(19) United States
(12) Patent Application Publication
(10) Pub. No.: US 2019/0001736 A1
(43) Pub. Date: Jan. 3, 2019

(54) WRITING APPARATUS AND A METHOD OF DISPENSING WRITING FLUID ON A WRITING SURFACE

(71) Applicant: WIPRO LIMITED, Bangalore (IN)

(72) Inventor: Amulya KUMAR DHAL, Singhpur (IN)

(73) Assignee: WIPRO LIMITED

(21) Appl. No.: 15/674,862

(22) Filed: Aug. 11, 2017

(30) Foreign Application Priority Data
Jun. 28, 2017 (IN) 201741022665

(51) Int. Cl. B43K 5/03; B43K 29/08; B01F 3/08; B01F 3/10; C09D 11/16; G06T 7/00

(52) U.S. Cl. CPC B43K 5/03; B43K 29/08; B01F 3/0803; B01F 3/10; B01F 2003/1278; G06T 7/001; B01F 2003/0884; B01F 2003/105; C09D 11/16

(57) ABSTRACT

The method of present disclosure relates to a writing apparatus for dispensing writing fluid on a writing surface. The writing apparatus comprises a sensor, containers for storing one or more mixing elements, a processor and a memory communicatively coupled to the processor. The writing apparatus compares the characteristics with predefined characteristics to determine quality of the writing surface. Further, the writing apparatus also determines a quality of the writing fluid suited for the writing surface. Based on the quality of the writing surface and the writing fluid, the writing apparatus modifies at least one property of the writing fluid before dispensing the writing fluid on the writing surface. For modifying the property, the one or more mixing elements are added into the writing fluid. Once the writing fluid is modified, the writing apparatus dispense the writing fluid on the writing surface.

### TECHNICAL FIELD

The present subject matter is related, in general to a writing apparatus and more particularly, to a method of dispensing writing fluid of the writing apparatus on to a writing surface.

### BACKGROUND

Writing apparatus, for example pens, are known from ages. It is one of a commonly used product in every age group in our society, be it a student, a teacher, or a professional. In earlier days nib-dip pens were used in which users were dependent upon an inkwell for recharging the nib while writing. With evolving time and technology, there has been an appreciable improvement in the field of a writing apparatus.

One of a challenge faced in the field of writing apparatus is non-suitability of an ink with a type of writing surface used for writing. This is because, characteristics of the writing surface like thickness and finishing may vary from one writing surface to another. It has been observed that due to slippery surface of the writing surface, it becomes difficult for users to write with a proper flow. While writing on such slippery writing surfaces, the users have to be cautious to prevent any inkblots or unwanted mark on the writing surface. Thus, there is a long-felt need in the art for determining the suitability of the ink relative to the writing surface.

### SUMMARY

Disclosed herein is a method of dispensing writing fluid, present in a writing apparatus, on a writing surface. The method includes scanning the writing surface. The scanning results in determination of one or more characteristics of the writing surface. The method further includes comparing the one or more characteristics with predefined characteristics. The one or more characteristics are associated with a quality of the writing surface. Further, the method includes determining the quality of the writing surface and a quality of the writing fluid suited for the writing surface based on the comparison. The method further includes modifying at least one property of the writing fluid based on the quality of the writing surface and the quality of the writing fluid before dispensing the writing fluid on the writing surface.

Further, the present disclosure relates to a writing apparatus for dispensing writing fluid on a writing surface. The writing apparatus comprises a sensor, one or more containers, a processor and a memory communicatively coupled to the processor. The sensor scans the writing surface. The scanning results in determination of one or more characteristics of the writing surface. Further, the one or more containers stores one or more mixing elements. The memory stores processor-executable instructions, which, on execution, causes the processor to compare the one or more characteristics with predefined characteristics. The one or more characteristics are associated with a quality of the writing surface. Further, the processor determines the quality of the writing surface and a quality of the writing fluid suited for the writing surface based on the comparison. Further, the processor modifies at least one property of the writing fluid based on the quality of the writing surface and the quality of the writing fluid before dispensing the writing fluid on the writing surface.

Furthermore, the present disclosure relates to a non-transitory computer readable medium including instructions stored thereon that when processed by at least one processor cause a writing apparatus to perform the acts of scanning a writing surface. The scanning results in determination of one or more characteristics of the writing surface. The instructions further cause the at least one processor to compare the one or more characteristics with predefined characteristics. The one or more characteristics are associated with a quality of the writing surface. Further, instructions cause the at least one processor to determine the quality of the writing surface and a quality of the writing fluid suited for the writing surface based on the comparison. The instructions further cause the at least one processor to modify at least one property of the writing fluid based on the quality of the writing surface and the quality of the writing fluid before dispensing the writing fluid on the writing surface.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE ACCOMPANYING DRAWINGS

The accompanying drawings, which are incorporated in and constitute a part of this disclosure, illustrate exemplary embodiments and, together with the description, explain the disclosed principles. In the figures, the left-most digit(s) of a reference number identifies the figure in which the reference number first appears. The same numbers are used throughout the figures to reference like features and components. Some embodiments of system and/or methods in accordance with embodiments of the present subject matter are now described, by way of example only, and regarding the accompanying figures, in which:

FIG. 1 is an exemplary environment for dispensing writing fluid, present in a writing apparatus, on a writing surface in accordance with some embodiments of the present disclosure;

FIG. 2 is a detailed block diagram of the writing apparatus in accordance with some embodiments of the present disclosure; and

FIG. 3 is a flowchart illustrating a method of dispensing writing fluid, present in the writing apparatus, on a writing surface in accordance with some embodiments of the present disclosure.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether such computer or processor is explicitly shown.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the specific forms disclosed, but on the contrary, the disclosure is to cover all modifications, equivalents, and alternative falling within the spirit and the scope of the disclosure.

The terms “comprises”, “comprising”, “includes”, or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or method.

The present disclosure relates to a writing apparatus for dispensing writing fluid on a writing surface. It is conventionally known that writing apparatus like ink pens, marker pens, highlighters, fine liner pens and the like are used for writing on a writing surface. The wilting apparatus contains the writing fluid, for example an ink, which is used for writing on the writing surface, for example a paper. However, the writing surface on which the writing apparatus is used in different instance of time may not be of same quality. This is because, the quality of the writing surface may differ due to different characteristics of the writing surface like coat weight, color, glossiness, opacity, surface topography, formation, strength, fiber orientation, and porosity.

As the quality of the writing surface differs, experience of writing also varies from one writing surface to another writing surface. For example, a user writing with same writing fluid may have different experiences while writing on a glossy paper, bond paper, matte paper, Bristol paper and a plain paper. The reason for such difference in the writing experience is not only because of the quality of the writing surface, as discussed above. But, the quality of the writing fluid also plays a vital role. The writing fluid with higher viscosity (i.e., one of a properties of the writing fluid) may not be suitable for writing on certain type of writing surface, for example plain paper, thereby creating an unpleasant user experience while writing. Thus, the writing apparatus disclosed in the present disclosure consider both the aspects for improving the writing experience of the user.

The quality of the writing surface and the quality of the writing fluid is determined. Based on their qualities, the writing apparatus may modify the properties of the writing fluid. Considering the above example, the writing apparatus may decrease the viscosity of the writing fluid for making it suitable for the writing surface like plain paper. For decreasing or increasing the viscosity, one or more mixing elements may be added into the writing fluid, However, before adding the one or more mixing elements into the writing fluid, appropriate amount or quantity of the one or more mixing elements may be determined. Once the appropriate amount of the one or more mixing elements are added into the writing fluid, the writing apparatus dispenses the writing fluid upon the writing surface.

In the following detailed description of the embodiments of the disclosure, reference is made to the accompanying drawings that form a part hereof, and which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

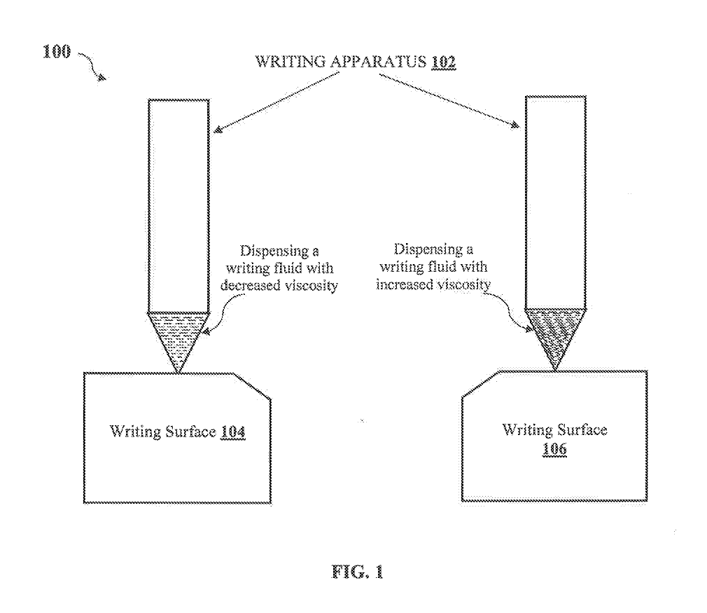

FIG. 1 is an exemplary environment for dispensing writing fluid, present in a writing apparatus, on a writing surface, in accordance with some embodiments of the present disclosure.

The environment 100 includes a writing apparatus 102 and two writing surfaces, for example a writing surface 104 and a writing surface 106. Examples of the writing apparatus 102 may include ink pens, marker pens, highlighters, fine liner pens and the like. However, it must be understood to a person skilled in art that the writing apparatus 102 may not be limited to an independent apparatus as shown in FIG. 1, but it may be a part of a printing machine or a printing device or any electronic device capable of holding and operating the writing apparatus 102. According to another embodiment, the writing apparatus 102 may be an automatic pen operated by a robot or any automated machine.

Further, the writing apparatus 102 may include components like nib, cap, spring, cartridge, barrel, feed, clip and the like. In FIG. 1, two embodiments have been shown using two writing surfaces i.e., the writing surface 104 and the writing surface 106. In one embodiment, shown at the left-hand side of the FIG. 1, the quality of the writing surface 104 may be such that it may suit the writing fluid of lesser viscosity. In another embodiment, shown at the right-hand side of the FIG. 1, the writing surface 106 may suit the writing fluid with higher viscosity. It must be understood to a person skilled in the art that viscosity is one example of properties of the writing fluid which may he modified before dispensing the writing fluid on the writing surface. Other examples of the properties of the writing fluid may include density, mass density, specific weight, relative density, specific volume, and specific gravity.

When the quality of the writing surface is determined, one or more properties of the writing fluid may be modified for making the writing fluid suitable for writing on the writing surface. It can be observed from the left-hand side of the FIG. 1, that the writing fluid dispensed on the writing surface 104 is of lesser density or viscosity. Whereas, at the right hand-side of the FIG. 1, it can be observed that the writing fluid dispensed on the writing surface 106 is of higher density or viscosity. The determination of the quality of the writing surfaces and writing fluid, and modifying of the writing fluid is explained in subsequent paragraphs of the specification.

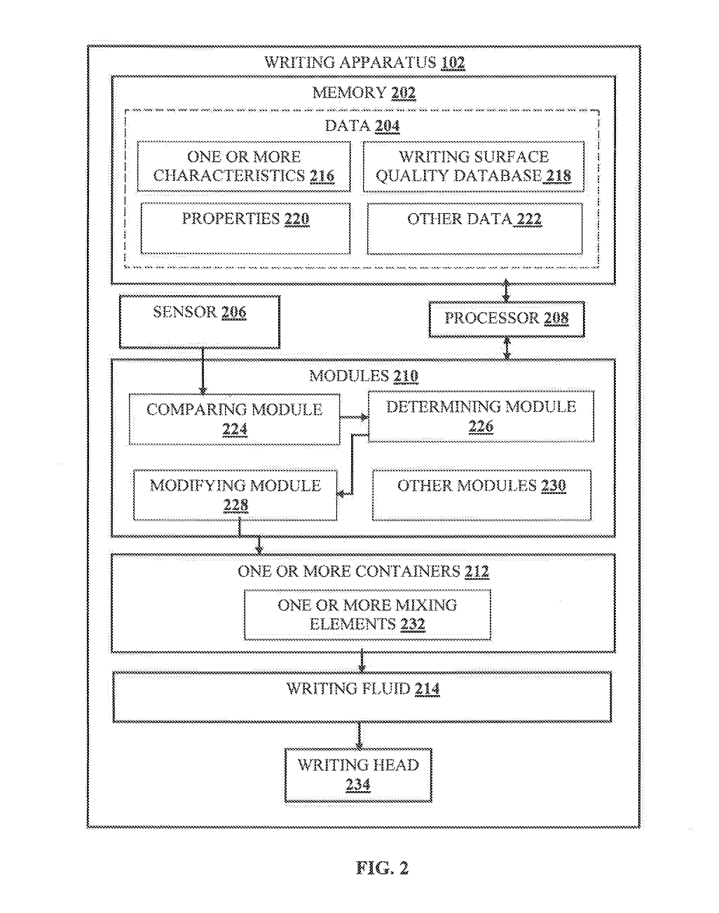

FIG. 2 is a detailed block diagram of the writing apparatus 102 in accordance with some embodiments of the present disclosure.

The writing apparatus 102 may include a memory 202, comprising data 204, a sensor 206, a processor 208, modules 210, one or more containers 212, writing fluid 214, and a writing head 234. The one or more containers 212 may include one or more mixing elements 232. The writing fluid 214 may include an ink or a coloring agent. The memory 202 may be communicatively coupled to the processor 208. The processor 208 may be configured to perform one or more functions of the writing apparatus 102 in dispensing the writing fluid 214 on a writing surface. In one implementation, the modules 210 may perform various operations of the writing apparatus 102 in accordance with the embodiments of the present disclosure. In an embodiment, the data 204 may be stored within the memory 202 and may include, without limiting to, one or more characteristics 216, writing surface quality database 218, properties 220 of the writing fluid 214, and other data 222.

In some embodiments, the data 204 may be stored within the memory 202 in the form of various data structures. Additionally, the data 204 may be organized using data models, such as relational or hierarchical data models. The other data 222 may store data, including temporary data and temporary files, generated by the modules 210 for performing the various functions of the writing apparatus 102.

In an embodiment, the one or more characteristics 216 may be associated with the writing surface which is used for determining the quality of the writing surface. The one or more characteristics 216 may include at least one of a coat weight, color, glossiness, opacity, surface topography, formation, strength, fiber orientation, and porosity of the writing surface.

In an embodiment, the writing surface quality database 218 may store predefined characteristics in such a manner that each of the predefined characteristics is mapped with corresponding quality of the writing surface. In an embodiment, the properties 220 of the writing fluid 214 may include at least one of viscosity, density, mass density, specific weight, relative density, specific volume, and specific gravity of the writing fluid 214.

In some embodiments, the data 204 may be processed by one or more modules 210 of the writing apparatus 102. In one implementation, the one or more modules 210 may be stored as a part of the processor 208. In another implementation, the one or more modules 210 may be communicatively coupled to the processor 208 for performing one or more functions of the writing apparatus 102. The modules 210 may include, without limiting to, a comparing module 224, a determining module 226, a modifying module 228, and other modules 230.

As used herein, the term ‘module’ refers to an application specific integrated circuit (ASIC), an electronic circuit, a processor (shared, dedicated, or group) and memory that execute one or more software or firmware programs, a combinational logic circuit, and/or other suitable components that provide the described functionality. In an embodiment, the other modules 230 may be used to perform various miscellaneous functionalities of the writing apparatus 102. It will be appreciated that such modules 210 may be represented as a single module or a combination of different modules.

In an embodiment, the sensor 206 (for example an image processing sensor) may scan the writing surface to be used for writing. The scanning of the writing surface may result in determination of the one or more characteristics 216 of the writing surface. As discussed earlier, different writing surfaces may have different qualities which may impact the writing experience of the user. For example, writing on a glossy paper may be difficult compared to a plain paper or a Bristol paper. This difficulty is encountered mainly due the difference in the one or more characteristics 216 of the writing surface.

According to an embodiment of present disclosure, the writing surface quality database 218 of the writing apparatus 102 stores the predefined characteristics of the writing surfaces. The predefined characteristics are stored in such a manner that each predefined characteristic is mapped with a corresponding quality. Thus, the writing surface quality database 218 is used as a reference for determining the quality of the writing surface. Few examples of the writing surface 104 with their corresponding characteristics is shown in below table 1

TABLE 1
Mapping of writing surface with corresponding characteristics

| Quality of Writing Surface | Corresponding characteristics with values |
|---|---|
| Plain Paper | Uncoated |
| | Glossiness <10 |
| | Opacity - 75-85 |
| | Surface topography - Rough |
| | Brightness - 80 |
| Bristol Paper | Less coated |
| | Glossiness - 25 |
| | Opacity - 85 to 92 |
| | Surface topography - smooth as glass |
| | Brightness - 75.0 ± 2.0 |
| | Roughness - 3.5 +/− 0.5 |
| Glossy paper | Glossiness - 65 |
| | Opacity - 90 |
| | Surface topography - Texture: Smooth |
| | Whiteness - 140 |
| | Brightness - 95-100 |
| General Use/Copy/ | Brightness - 80-100 |
| Multiuse Paper | Opacity - Medium-High |
| Premium/Business/Choice | Brightness - 92-100 |
| Paper | Opacity - High |
| Resume/Stationary/Linen | Brightness - 80-100 |
| Paper | Opacity - High |
| Card Stock/Cover Stock | Brightness - 80-100 |
| Paper | Opacity - High |
| Photo/Imaging Paper | Brightness - 75-110 |
| | Opacity - High |
| Bond | Brightness - 80 |
| | Opacity - 80 |
| Antique wove and antique | Brightness - 72 |
| laid | Opacity - 80 |
| Printing Maplitho | Brightness - 77 |
| | Opacity - 80 |

From the above table 1, it can be observed that characteristics varies from one writing surface 104 to another writing surface 104 based on their quality. One of the characteristic opacity indicates how likely something printed on one side of the writing surface 104 is shown on the opposite side of the writing surface 104. On a scale of 0 to 100, 0 indicates completely clear and 100 indicates completely opaque. According to embodiments, the characteristic opacity may also be shown as medium, high, and very high as shown in the above table 1.

In an embodiment, the comparing module 224 may compare the one or more characteristics 216 scanned by the sensor 206 with the predefined characteristics stored in the writing surface quality database 218. Based on the comparison, the determining module 226 may determine the quality of the writing surface to be used for writing. Further, the determining module 226 may also determine the quality of the writing fluid 214 suited for the quality of writing surface. As explained in FIG. 1, the two different writing surfaces i.e., the writing surface 104 and the writing surface 106 requires different qualities of the writing fluid 214 for smooth or convenient writing.

The quality of the writing surface is used to determine whether it requires the writing fluid 214 to be of a higher or lower viscosity than the current viscosity of the original writing fluid 214 present in the writing apparatus 102. However, it must be understood to a person skilled in art that other examples of the properties 220 of the writing fluid 214 may also get modified based on the quality of the writing surface.

In an embodiment, the modifying module 228 of the writing apparatus 102 may modify at least one of the properties 220 of the writing fluid 214 before dispensing the writing fluid 214 on the writing surface. In a first step, the modifying module 228 may determine one of an increase and decrease of the at least one property of the properties 220 of the writing fluid 214 based on the quality of the writing surface and the quality of the writing fluid 214. For example, if it is determined that the viscosity (one of the properties 220) of the writing fluid 214 has to be increased, the modifying module 228 may trigger one of the one or more containers 212 and accordingly the corresponding mixing element is selected for increasing the viscosity of the writing fluid 214.

The one or more mixing elements 232 may be chemical or fluid capable of increasing or decreasing the properties 220 of the writing fluid 214. In one example, one of the mixing elements 232 may be a glycerol, stored in container I of the one or more containers 212, which is capable of increasing the viscosity of the writing fluid 214 to suit the quality of the writing surface. In another example, one of the mixing elements 232 may be deionized water, stored in container 2 of the one or more containers 212, which is capable of decreasing the viscosity of the writing fluid 214 to suit the quality of the writing surface.

Now, once the one or more mixing elements 232 is selected, the next step performed by the modifying module 228 is to determine an amount, of the one or more mixing elements 232, to be added for increasing the viscosity of the writing fluid 214. Upon determining the amount, the modifying module 228 may trigger the container 1 to add the mixing element 232_(glycerol) into the writing fluid 214 for increasing the viscosity. After increasing the viscosity, the writing fluid 214 becomes suitable as per the quality of the writing surface. However, alternatively, if the viscosity of the writing fluid 214 has to be decreased, the modifying module 228 may trigger the container 2 for adding the mixing element 232 (deionized water) into the writing fluid 214 for decreasing the viscosity. Now, the writing apparatus 102 may dispense the writing fluid 214 upon the writing surface through the writing head 234 of the writing apparatus 102.

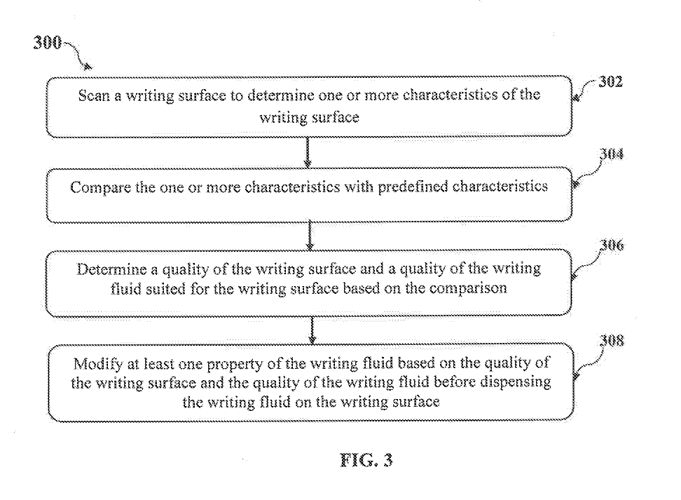

FIG. 3 is a flowchart illustrating a method of dispensing writing fluid, present in the writing apparatus, on a writing surface in accordance with some embodiments of the present disclosure.

As illustrated in FIG. 3, the method 300 includes one or more blocks illustrating a method of dispensing writing fluid 214 using the writing apparatus 102. The method 300 may be described in the general context of computer executable instructions. Generally, computer executable instructions can include routines, programs, objects, components, data structures, procedures, modules, and functions, which perform specific functions or implement specific abstract data types.

The order in which the method 300 is described is not intended to be construed as a limitation, and any number of the described method blocks can be combined in any order to implement the method. Additionally, individual blocks may be deleted from the methods without departing from the spirit and scope of the subject matter described herein. Furthermore, the method can be implemented in any suitable hardware, software, firmware, or combination thereof.

At block 302, the method 300 includes scanning, by a sensor 206 of the writing apparatus 102, the writing surface. The scanning results in determination of one or more characteristics 216 of the writing surface. Further, the one or more characteristics 216 includes at least one of coat weight, color, glossiness, opacity, surface topography, formation, strength, fiber orientation, and porosity of the writing surface.

At block 304, the method 300 includes comparing, by the writing apparatus 102, one or more characteristics 216 with predefined characteristics. Further, the one or more characteristics 216 are associated with a quality of the writing surface. Further, the predefined characteristics are stored in a writing surface quality database 218. The writing surface quality database 218 includes a mapping of each of the predefined characteristics with corresponding quality.

At block 306, the method 300 includes determining, by the writing apparatus 102, quality of the writing surface and a quality of the writing fluid 214 suited for the writing surface based on the comparison. The writing fluid 214 may include at least one of an ink and a coloring agent

At block 308, the method 300 includes modifying, by the writing apparatus 102, at least one property of properties 220 of the writing fluid 214 based on the quality of the writing surface and the quality of the writing fluid 212 before dispensing the writing fluid 214 onto the writing surface. The at least one property of the properties 220 may include viscosity, density, mass density, specific weight, relative density, specific volume, and specific gravity of the writing fluid 214.

For modifying the property, the one or more mixing elements 232 are added into the writing fluid 214. Once the writing fluid 214 is modified, the writing apparatus 102 dispenses the writing fluid 21.4 on the writing surface.

Advantages of the Embodiment of the Present Disclosure are Illustrated Herein.

In an embodiment, the present disclosure provides a method for providing a better writing experience to a user.

In an embodiment, the method of the present disclosure resolves the issues of ink blotting and ink dispersion on the writing surface.

In an embodiment, the method of the present disclosure provides a one-stop solution by enabling the writing apparatus to modify the writing fluid in real-time based on the quality of the writing surface.

The terms “an embodiment”, “embodiment”, “embodiments”, “the embodiment”, “the embodiments”, “one or more embodiments”, “some embodiments”, and “one embodiment” mean “one or more (but not all) embodiments of the invention(s)” unless expressly specified otherwise.

The terms “including”, “comprising”, “having” and variations thereof mean “including but not limited to”, unless expressly specified otherwise.

The enumerated listing of items does not imply that any or all the items are mutually exclusive, unless expressly specified otherwise.

The terms “a”, “an” and “the” mean “one or more”, unless expressly specified otherwise.

A description of an embodiment with several components in communication with each other does not imply that all such components are required. On the contrary, a variety of optional components are described to illustrate the wide variety of possible embodiments of the invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the embodiments of the present invention are intended to be illustrative, but not limiting, of the scope of the invention, which is set forth in the following claims.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

### REFERENCE NUMERALS

| Reference Number | Description |
|---|---|
| 100 | ENVIRONMENT |
| 102 | WRITING APPARATUS |
| 104 | WRITING SURFACE |
| 106 | WRITING SURFACE |
| 202 | MEMORY |
| 204 | DATA |
| 206 | SENSOR |
| 208 | PROCESSOR |
| 210 | MODULES |
| 212 | ONE OR MORE CONTAINERS |
| 214 | WRITING FLUID |
| 216 | ONE OR MORE CHARACTERISTICS |
| 218 | WRITING SURFACE QUALITY DATABASE |
| 220 | PROPERTIES |
| 222 | OTHER DATA |
| 224 | COMPARING MODULE |
| 226 | DETERMINING MODULE |
| 228 | MODIFYING MODULE |
| 230 | OTHER MODULES |
| 232 | ONE OR MORE MIXING ELEMENTS |
| 234 | WRITING HEAD |

1. A method of dispensing writing fluid, present in a writing apparatus, on a writing surface, the method comprising:
scanning, by a sensor of the writing apparatus, the writing surface, wherein the scanning results in determination of one or more characteristics of the writing surface;
comparing, by the writing apparatus, the one or more characteristics with predefined characteristics, wherein the one or more characteristics are associated with a quality of the writing surface;
determining, by the writing apparatus, the quality of the writing surface and a quality of the writing fluid suited for the writing surface based on the comparison; and
modifying, by the writing apparatus, at least one property of the writing fluid based on the quality of the writing surface and the quality of the writing fluid before dispensing the writing fluid on the writing surface.

2. The method as claimed in claim 1, wherein the one or more characteristics comprises at least one of a coat weight, color, glossiness, opacity, surface topography, formation, strength, fiber orientation, and porosity.

3. The method as claimed in claim 1, wherein the predefined characteristics are stored in a writing surface quality database, wherein the writing surface quality database comprises a mapping of each of the predefined characteristics with corresponding quality.

4. The method as claimed in claim 1, wherein the writing fluid comprises at least one of an ink and a coloring agent.

5. The method as claimed in claim 1, wherein the at least one property comprises viscosity, density, mass density, specific weight, relative density, specific volume, and specific gravity of the writing fluid.

6. The method as claimed in claim 1, wherein modifying the at least one property of the writing fluid comprises:
determining one of an increase and decrease of the at least one property of the writing fluid based on the quality of the writing surface and the quality of the writing fluid;
determining an amount of one or more mixing elements, stored in one or more containers of the writing apparatus, to be added for one of increasing and decreasing the at least one property of the writing fluid; and
adding the amount of the one or more mixing elements into the writing fluid.

7. A writing apparatus for dispensing writing fluid on a writing surface, the writing apparatus comprising:
a sensor for scanning the writing surface, wherein the scanning results in determination of one or more characteristics of the writing surface;
one or more containers for storing one or more mixing elements;
a processor; and
a memory communicatively coupled to the processor, wherein the memory stores processor-executable instructions, which, on execution, causes the processor to:
compare the one or more characteristics with predefined characteristics, wherein the one or more characteristics are associated with a quality of the writing surface;
determine the quality of the writing surface and a quality of the writing fluid suited for the writing surface based on the comparison; and
modify at least one property of the writing fluid based on the quality of the writing surface and the quality of the writing fluid before dispensing the writing fluid on the writing surface.

8. The writing apparatus as claimed in claim 7, wherein the one or more characteristics comprises at least one of a coat weight, color, glossiness, opacity, surface topography, formation, strength, fiber orientation, and porosity.

9. The writing apparatus as claimed in claim 7, wherein the predefined characteristics are stored in a writing surface quality database, wherein the writing surface quality database comprises a mapping of each of the predefined characteristics with corresponding quality.

10. The writing apparatus as claimed in claim 7, wherein the writing fluid comprises at least one of an ink and a coloring agent.

11. The writing apparatus as claimed in claim 7, wherein the at least one property comprises viscosity, density, mass density, specific weight, relative density, specific volume, and specific gravity of the writing fluid.

12. The writing apparatus as claimed in claim 7, wherein the writing apparatus modifies the at least one property of the writing fluid by:
determining one of an increase and decrease of the at least one property of the writing fluid based on the quality of the writing surface and the quality of the writing fluid;
determining an amount, of the one or more mixing elements, to be added for one of increasing and decreasing the at least one property of the writing fluid; and
adding the amount of the one or more mixing elements into the writing fluid.

13. A non-transitory computer-readable storage medium including instructions stored thereon that when processed by at least one processor cause a writing apparatus to perform operations comprising:
scanning a writing surface, wherein the scanning results in determination of one or more characteristics of the writing surface;
comparing the one or more characteristics with predefined characteristics, wherein the one or more characteristics are associated with a quality of the writing surface;
determining the quality of the writing surface and a quality of the writing fluid suited for the writing surface based on the comparison; and
modifying at least one property of the writing fluid based on the quality of the writing surface and the quality of the writing fluid before dispensing the writing fluid on the writing surface.

14. The medium as claimed in claim 13, wherein the one or more characteristics comprises at least one of a coat weight, color, glossiness, opacity, surface topography, formation, strength, fiber orientation, and porosity.

15. The medium as claimed in claim 13, wherein the predefined characteristics are stored in a writing surface quality database, wherein the writing surface quality database comprises a mapping of each of the predefined characteristics with corresponding quality.

16. The medium as claimed in claim 13, wherein the writing fluid comprises at least one of an ink and a coloring agent.

17. The medium as claimed in claim 13, wherein the at least one property comprises viscosity, density, mass density, specific weight, relative density, specific volume, and specific gravity of the writing fluid.

18. The medium as claimed in claim 13, wherein modifying the at least one property of the writing fluid comprises:
determining one of an increase and decrease of the at least one property of the writing fluid based on the quality of the writing surface and the quality of the writing fluid;
determining an amount of one or more mixing elements, stored in one or more containers of the writing apparatus, to be added for one of increasing and decreasing the at least one property of the writing fluid; and
adding the amount of the one or more mixing elements into the writing fluid.
